(19) United States
(12) Patent Application Publication
(10) Pub. No.: US 2026/0133557 A1
(43) Pub. Date: May 14, 2026

(54) EQUIPMENT CALIBRATION SYSTEM AND METHOD OF OPERATING THE SAME

(71) Applicant: SAMSUNG SDI CO., LTD., Yongin-si (KR)

(72) Inventors: KEUNSIK YOO, Yongin-si (KR); Jaedeuk Lee, Yongin-si (KR)

(21) Appl. No.: 19/360,431

(22) Filed: Oct. 16, 2025

(30) Foreign Application Priority Data
Nov. 14, 2024 (KR) 10-2024-0162550

(51) Int. Cl. G05B 19/404

(52) U.S. Cl. CPC G05B 19/404; G05B 2219/37506

(57) ABSTRACT

A calibration system includes: a calibration device; an operating computer configured to acquire monitoring data generated from calibration target equipment and to determine whether or not to perform calibration on the target equipment based on the monitoring data; and a transport device configured to transport the calibration device and to mount the calibration device on the target equipment when it is determined that calibration is to be performed on the target equipment. The calibration device is configured to collect calibration data from the target equipment and to transmit the calibration data to the operating computer after the calibration device is mounted on the target equipment, and the operating computer is configured to calculate a correction factor for the monitoring data based on the calibration data.

### CROSS-REFERENCE TO RELATED APPLICATION

The present application claims priority to and the benefit of Korean Patent Application No. 10-2024-0162550, filed on Nov. 14, 2024, in the Korean Intellectual Property Office, the entire disclosure of which is incorporated herein by reference.

### BACKGROUND

### 1. Field

Aspects of embodiments of the present disclosure relate to an equipment calibration system and a method of operating the same.

### 2. Description of the Related Art

The accuracy and precision of industrial equipment degrade over time. Numerous factors can cause degradation in precision, such as an operating environment, operating frequency, and durability of parts or components of equipment. Equipment with degraded accuracy cannot be expected to generate an output consistent with its purpose, and products manufactured by using the equipment are also affected due to the degraded accuracy.

A process of recovering (e.g., correcting) and verifying the accuracy of such inaccurate equipment is called correction or calibration. Generally, a process of performing calibration is as follows:
(1) Determine whether or not to perform calibration when an equipment inspection cycle arrives or a defective rate of products increases;
(2) Mount a calibration jig and a measuring device on target equipment to measure the accuracy and precision of the target equipment;
(3) Correct accuracy and precision (e.g., apply an offset and a gain); and
(4) Re-measure accuracy and precision.

However, conventionally, an operator manually handles both determination of a calibration time point (e.g., a time to perform the calibration) and determination whether or not to perform calibration in many cases. Accordingly, it is difficult to determine an appropriate calibration time point, and it can take a long time to perform calibration, thereby degrading the precision of equipment and causing loss of manufacturing efficiency.

The above information disclosed in this Background section is for enhancement of understanding of the background of the present disclosure, and therefore, it may contain information that does not constitute a related (or prior) art.

### SUMMARY

Embodiments of the present disclosure provide an equipment calibration system that is configured to determine a calibration time point based on collected data and, when performing calibration, automatically performing movement and setup of a jig and a measuring device, measurement of calibration data, and generation, application, and verification of correction data, and a method of operating the same.

Aspects and features of the present disclosure are not limited to the above-described aspects and features, and other aspects and features that are not mentioned will be able to be clearly understood by those skilled in the art from the following description.

According to an embodiment of the present disclosure, a calibration system includes a calibration device, an operating computer configured to acquire monitoring data generated from calibration target equipment and to determine whether or not to perform calibration on the target equipment based on the monitoring data, and a transport device configured to transport the calibration device and mount the calibration device on the target equipment when it is determined that calibration is to be performed on the target equipment.

After the calibration device is mounted on the target equipment, the calibration device may collect calibration data from the target equipment and transmit the calibration data to the operating computer.

The operating computer may calculate a correction factor for the monitoring data based on the calibration data.

According to another embodiment of the present disclosure, a method of operating a calibration system includes acquiring, by an operating computer, monitoring data generated from calibration target equipment, determining, by the operating computer, whether or not to perform calibration on the target equipment based on the monitoring data, transporting, by a transport device, a calibration device and mounting the calibration device on the target equipment when it is determined by the operating compute that calibration is to be performed on the target equipment, collecting, by the calibration device, calibration data from the target equipment and transmitting the calibration data to the operating computer after the calibration device is mounted on the target equipment, and calculating, by the operating computer, a correction factor for the monitoring data based on the calibration data.

Aspects and features of the present disclosure are not limited to those described above, and other aspects and features not specifically mentioned herein will be clearly understood by those skilled in the art from the description of the present disclosure below.

### BRIEF DESCRIPTION OF THE DRAWINGS

The above and other aspects and features of the present disclosure will become more apparent to those of ordinary skill in the art by describing embodiments thereof, in detail, with reference to the accompanying drawings, in which:

FIG. 1 is a block diagram describing an equipment calibration system according to an embodiment of the present disclosure;

FIG. 2 is a flowchart describing a method of operating an equipment calibration system according to an embodiment of the present disclosure;

FIG. 3 is a block diagram describing a method of operating an equipment calibration system according to an embodiment of the present disclosure;

FIG. 4 is a block diagram describing a configuration of a calibration device according to an embodiment of the present disclosure;

FIG. 5 is a schematic illustration of a measuring circuit included in the calibration device according to an embodiment of the present disclosure;

FIG. 6 is a schematic illustration of a calibration device according to an embodiment of the present disclosure;

FIG. 7 is a perspective view of a sensor for detecting a calibration device; and

FIG. 8 is a block diagram describing a configuration of a computer system.

### DETAILED DESCRIPTION

Hereinafter, embodiments of the present disclosure will be described, in detail, with reference to the accompanying drawings. The terms or words used in the present specification and claims should not be narrowly interpreted according to their general or dictionary meanings but should be interpreted as having meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of about 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

An equipment calibration system 100 (hereinafter referred to as a “calibration system”) according to an embodiment of the present disclosure is configured to determine a calibration time point (S1), to move and set a calibration jig and a measuring device (S2), and to measure, apply, and verify calibration data (S3).

Operation S1 is performed by operating software. The calibration system 100 acquires monitoring data, such as voltage, current, and capacity, generated in target equipment 20 in real time and determines an outlier from among the monitoring data generated from the target equipment 20.

Operation S2 is performed by operating hardware and software. The calibration system 100 moves the calibration jig and a calibration device 150 and automatically performs setup. For example, the calibration system 100 moves the jig and the calibration device 150 at the same time by using a transport device 140 (e.g., a stacker crane) or the like and mounts the calibration device 150 at a target position.

Operation S3 is performed by operating hardware and software. For example, the calibration system 100 acquires calibration data by driving software (which may be installed on an operating computer 110) linked to the calibration jig and the calibration device 150, generates correction data (e.g., correction factors, such as an offset, a slope, or a gain of the slope), applies the correction data, and automatically performs verification thereof.

In describing the present disclosure, when it is determined that the detailed description of a related known technology may unnecessarily obscure the gist of the present disclosure, detailed description thereof will be omitted or only briefly provided.

Hereinafter, embodiments of the present disclosure will be described, in detail, with reference to the accompanying drawings. To facilitate overall understanding in the description of the present disclosure, the same reference numbers will be used for the same elements regardless across the drawings.

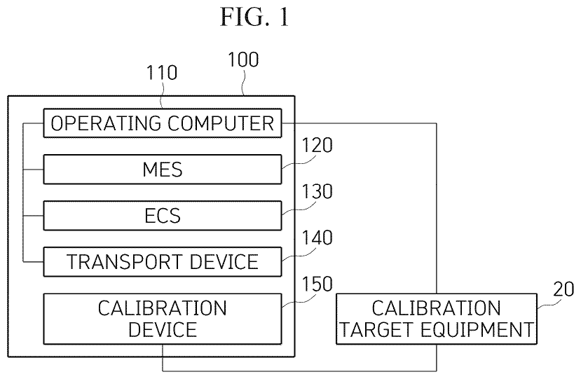

FIG. 1 is a block diagram describing an equipment calibration system according to an embodiment of the present disclosure.

The calibration system 100, according to an embodiment of the present disclosure, includes the operating computer 110, a manufacturing execution system (MES) 120, an equipment control system (ECS) 130, the transport device 140, and the calibration device 150.

The calibration system 100, according to an embodiment, is illustrated in FIG. 1. Components of the calibration system 100, according to embodiments of the present disclosure, are not limited to that illustrated in FIG. 1, and some components may be added, changed, or omitted as needed. For example, the operating computer 110 may directly transmit a command for the position and movement of the calibration target equipment 20 to the transport device 140, and in such an embodiment, the MES 120 and the ECS 130 are not included in the calibration system 100.

The calibration target equipment 20 (hereinafter referred to as “target equipment”) is equipment to be calibrated by the calibration system 100. In the present specification, an example in which a charger/discharger used for charging/discharging a battery is the target equipment 20 will be described. By way of background, a process of manufacturing a battery generally includes an electrode plate process, an assembly process, and a formation process, and from among these processes, the formation process is a process of activating a battery to have electrical characteristics and determining whether or not a defect is present in the battery. The formation process generally includes a charging/discharging process, a stabilizing process, a grading process, and a defect sorting process. The charging/discharging process is a process of activating a battery from a no charge state through first charging, and, in some cases, a thin solid electrolyte interphase (SEI) layer is formed on a surface of a negative electrode of the battery. In the present disclosure, the calibration target equipment 20 may be a charger/discharger for charging and discharging a battery in the charging/discharging process. However, the target equipment 20 of the present disclosure is not limited to a charger/discharger.

The operating computer 110 acquires monitoring data generated (or measured) from the target equipment 20 and determines whether or not to perform calibration on the target equipment based on the monitoring data. For example, when the target equipment 20 is a charger/discharger, the monitoring data may include voltage, current, capacity, and temperature measured from the target equipment 20 when the target equipment 20 charges or discharges a battery.

The operating computer 110 periodically (e.g., at two-second intervals) acquires monitoring data measured in (or generated by) the target equipment 20 from the target equipment 20, determines accuracy and precision of the monitoring data through outlier analysis for the monitoring data, and determines whether or not to perform calibration on the target equipment 20 (e.g., determines whether or not calibration is required) based on the result of the determination.

When the operating computer 110 determines that calibration needs to be performed on the target equipment 20, the transport device 140 transports the calibration device 150 and moves the calibration device 150 to a position at which the target equipment 20 is positioned and causes the calibration device 150 to be mounted on the target equipment 20.

For example, when the operating computer 110 determines that calibration needs to be performed on the target equipment 20, the operating computer 110 transmits a calibration alarm (e.g., a calibration signal or interrupt) to the MES 120. Upon receiving the calibration alarm from the operating computer 110, the MES 120 transmits information on the position of the target equipment 20 to the ECS 130. The ECS 130 transmits a command for the position and movement of the target equipment 20 to the transport device 140.

For example, when the target equipment 20 is a charger/discharger, the target equipment 20 may be disposed in a rack. In such an embodiment, a position of the target equipment 20 transmitted to the ECS 130 by the MES 120 may be a position of the rack at which the target equipment 20 is disposed. In addition, when the target equipment 20 is disposed in the rack, the transport device 140 may be a stacker crane.

Upon receiving the command for the position and movement of the target equipment 20 from the ECS 130, the transport device 140 moves to the position at which the calibration device 150 is positioned and transports the calibration device 150 to the position of the target equipment 20. The transport device 140 may mount the calibration device 150 on the target equipment 20.

After the calibration device 150 is mounted on the target equipment 20, power is automatically applied to the calibration device 150, and a communication connector is connected to the calibration device 150 so that the calibration device 150 is connected to a network (e.g., a communication network) to which the operating computer 110 is connected. Accordingly, the calibration device 150 may transmit calibration data acquired through the calibration performed on the target equipment 20 to the operating computer 110. In addition, the target equipment 20 and the calibration device 150 are electrically connected.

The target equipment 20, the structure (e.g., the rack) in which the target equipment 20 is positioned, or the transport device 140 may include a connecting device.

A sensor 160 is disposed on a path along which the calibration device 150 enters the position of the target equipment 20 (or the rack in which the target equipment 20 is positioned), and the sensor 160 generates a detection signal for the calibration device 150 when the calibration device 150 is close to the sensor 160 (e.g., when the calibration device 150 is positioned within a reference (or predetermined) distance) and transmits the detection signal to the connecting device. The connecting device connects a power connector to a power input terminal 151 of the calibration device 150 to apply power to the calibration device 150 and connects the communication connector to a communication port 152 of the calibration device 150 so that the calibration device 150 is connected to the network to which the operating computer 110 is connected. In addition, the connecting device couples a plus (positive) connector and a minus (negative) connector to plus (positive) terminals and minus (negative) terminals of the calibration device 150 and the target equipment 20, respectively, so that the calibration device 150 and the target equipment 20 are electrically connected. When the target equipment 20 is a charger/discharger, the plus (positive) connector and the minus (negative) connector are the same as connectors of a battery (e.g., a cell), and the calibration device 150 simulates the battery.

For example, the connecting device includes a cable clamp for holding a power connector, a communication connector, a plus connector, and a minus connector, a hydraulic cylinder for supplying power to the cable clamp, a motion sensor for detecting movement of the cable clamp, and a controller for controlling a position of the cable clamp based on sensing data of the motion sensor.

When power is applied to the calibration device 150 and the calibration device 150 is electrically connected to the target equipment 20, the calibration device 150 starts the calibration of the target equipment 20. The calibration device 150 collects calibration data from the target equipment 20 and transmits the calibration data to the operating computer 110. When the target equipment 20 is a charger/discharger, the calibration data may include current, voltage, and capacity measured from the calibration device 150 when the charger/discharger operates in a charging mode or a discharging mode. In such an example, the calibration device 150 may be automatically switched to the mode by using a built-in relay 153e. The modes of calibration device 150 may be represented by Table (1) below. For example, (1) in Table 1 refers to a charging mode+a current measuring mode.

TABLE 1

| | Current | Voltage | Capacity |
|---|---|---|---|
| | measuring | measuring | measuring |
| | mode | mode | mode |
| Charging mode | (1) | (2) | (3) |
| Discharging mode | (4) | (5) | (6) |

That is, the calibration device 150 may set one of the charging mode and the discharging mode by using the relay 153e to calibrate the target equipment 20 and set one of the current measuring mode, the voltage measuring mode, and the capacity measuring mode.

The calibration device 150 may transmit calibration data to the operating computer 110, and the operating computer 110 may calculate a correction factor for the monitoring data generated from the target equipment 20 based on the calibration data. For example, the correction factor may include an offset and a slope (or a gain that adjusts the slope). After calculating the correction factor, the operating computer 110 transmits the calculated correction factor to the target equipment 20, stores the received correction factor in a built-in memory, and applies the stored correction factor to subsequent generation of monitoring data.

As another example, when the calibration device 150 performs calibration on the target equipment 20, the operating computer 110 may collect calibration data from the calibration device 150, may also collect monitoring data from the target equipment 20, and may calculate a correction factor to be applied to the target equipment 20 based on the calibration data and the monitoring data.

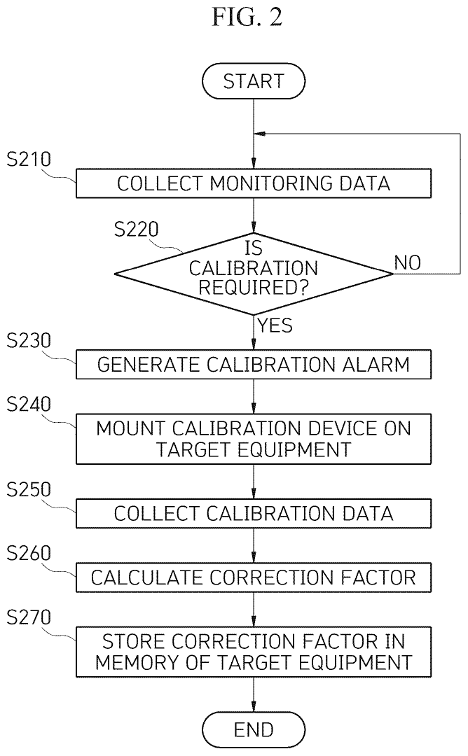

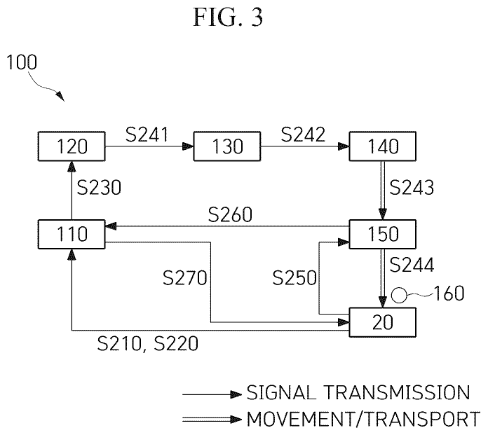

FIG. 2 is a flowchart describing a method of operating an equipment calibration system according to an embodiment of the present disclosure, and FIG. 3 is a block diagram describing a method of operating an equipment calibration system according to an embodiment of the present disclosure. Operating methods illustrated in FIGS. 2 and 3 may be performed by the calibration system 100 illustrated in FIG. 1.

Referring to FIG. 2, the method of operating a calibration system, according to an embodiment of the present disclosure, includes operations S210 to S270. Operations S241 to S244 in FIG. 3 are included in operation S240 in FIG. 2. The method of operating a calibration system, according to an embodiment, is illustrated in FIGS. 2 and 3, but operations of the method of operating a calibration system according to the present disclosure are not limited to the embodiment illustrated in FIGS. 2 and 3, and some steps and/or components may be added, changed, or omitted as needed.

### Operation S210—Collecting Monitoring Data.

The operating computer 110 acquires monitoring data (e.g., charging/discharging data) generated from the target equipment 20. The target equipment 20 may be a charger/discharger used for charging/discharging a battery. In this case, the monitoring data may be data measured by the target equipment 20 or corrected data of a measured value when the target equipment 20 charges or discharges a battery and may include one of current, voltage, capacity, and temperature or a combination thereof. The operating computer 110 may collect monitoring data from the target equipment 20 in real time and periodically (e.g., at two-second intervals).

### Operation S220—Determining Whether or not to Perform Calibration.

The operating computer 110 determines whether or not to perform calibration on the target equipment 20 based on the monitoring data received from the target equipment 20. For example, the operating computer 110 may perform statistical analysis, such as outlier analysis, on the monitoring data to calculate the accuracy and/or precision of the monitoring data and determine whether or not calibration is required for the target equipment 20 (e.g., determine whether or not the target equipment 20 requires calibration) based on the calculated accuracy and/or precision. The calibration system 100 performs operation S230 when the operating computer 110 determines that calibration of the target equipment 20 is required and, otherwise, continuously performs operations S210 and S220.

### Operation S230—Generating a Calibration Alarm.

When determining that calibration needs to be performed on the target equipment 20, the operating computer 110 generates a calibration alarm (e.g., a calibration signal or interrupt) and transmits the generated calibration alarm to the MES 120.

Operation S240 is an operation of mounting the calibration device on the target equipment. This operation is an operation of transporting, by the transport device 140, the calibration device and mounting the calibration device on the target equipment 20 when it is determined that calibration needs to be performed on the target equipment 20.

When the MES 120 receives a calibration alarm from the operating computer 110, the MES 120 transmits information on the position (or the position and movement command) of the target equipment 20 to the ECS 130 (S241). The ECS 130 transmits a command for the position and movement of the target equipment 20 to the transport device 140 (S242). The transport device 140 moves to the position at where the calibration device 150 is positioned (S243).

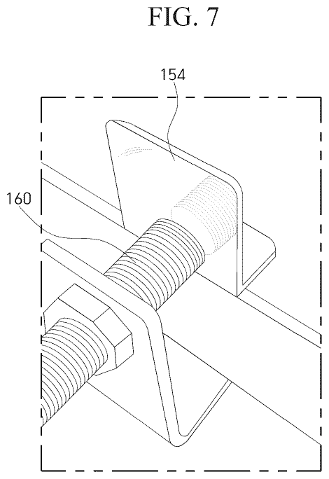

Then, the transport device 140 transports the calibration device 150 and moves the calibration device 150 to the position of the target equipment 20. When the calibration device 150 reaches a point at where it can be connected to the target equipment 20 by a cable, the sensor 160 detects the calibration device 150 (see, e.g., FIG. 7). When the sensor 160 generates a signal indicating that the calibration device 150 is detected, power is supplied to the calibration device 150, the calibration device 150 is connected to the network to which the operating computer 110 is connected, and the target equipment 20 and the calibration device 150 are electrically connected to start calibration (S244).

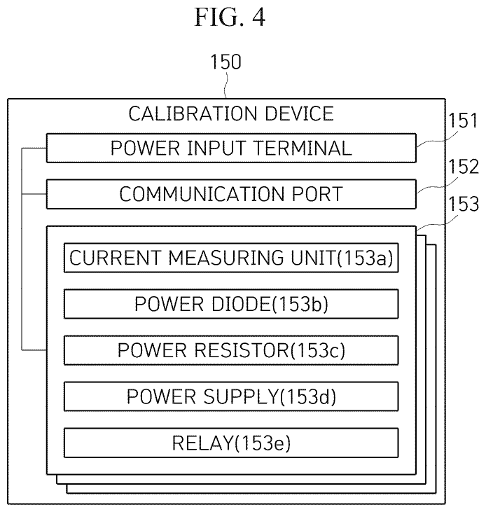

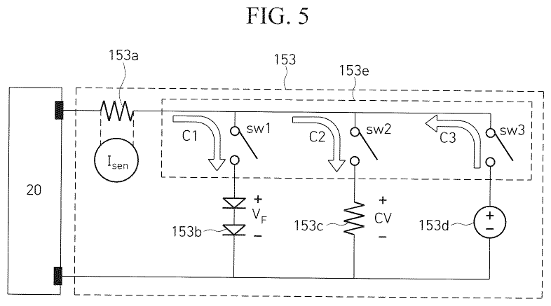

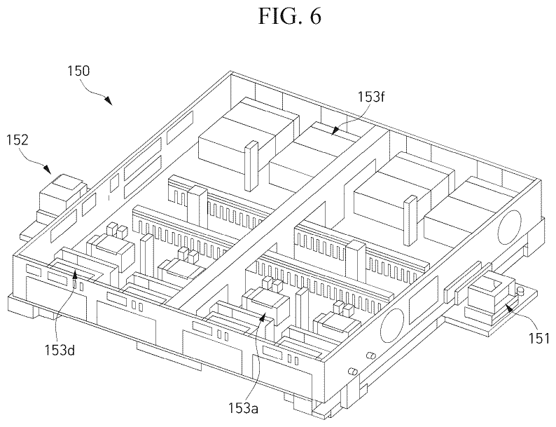

FIG. 4 is a block diagram describing a configuration of a calibration device according to an embodiment of the present disclosure, and FIG. 5 is a schematic view of a measuring circuit included in the calibration device according to an embodiment of the present disclosure. FIG. 6 is a schematic view of the calibration device according to an embodiment of the present disclosure.

The calibration device 150, according to an embodiment of the present disclosure, includes a power input terminal 151, a communication port 152, and a measuring circuit 153. The measuring circuit 153 includes a current measuring unit 153a, a power diode 153b, a power resistor 153c, a power supply 153d, and a relay 153e. The calibration device 150 may further include a multimeter display 153f.

A battery-less structure using (or including) the power diode 153b and the power resistor 153c is applied to the calibration device 150, according to an embodiment of the present disclosure. Accordingly, the calibration device 150, according to an embodiment of the present disclosure, does not require maintenance because it does not deteriorate like a battery.

FIG. 7 is a perspective view of the sensor 160 for detecting a calibration device, and the sensor 160 distinguishes the calibration device 150 from a general tray (e.g., a cell tray). For example, the cell tray may be formed of wood or plastic, and the calibration device 150 may have a part of a lower plate 154 or a lower portion of the power input terminal 151 (see, e.g., FIG. 6) formed of a metal. In this case, the sensor 160 may be an eddy current sensor for detecting a metal. For example, when the sensor 160 applies a high-frequency current to a coil and a conductor (e.g., a metal component) mounted on the calibration device 150 approaches the sensor 160, an eddy current caused by an alternating magnetic field generated by the coil flows through the conductor. When such an eddy current is generated, the sensor 160 may detect that an approaching object is the calibration device 150 and otherwise, recognize that the approaching object is another device (e.g., a cell tray) (e.g., may not recognize the other device). The sensor 160 may be disposed on a path toward the target equipment 20 or at an inlet of the target equipment 20 to recognize whether or not the calibration device 150 has entered the position of the target equipment 20. Because the process in which power is applied to the calibration device 150 as the connecting device is triggered by the detection signal of the sensor 160, the calibration device 150 is connected to the network, and the target equipment 20 and the calibration device 150 are electrically connected has been described above, a repeated detailed description thereof will be omitted.

Referring back to FIGS. 2 and 3, operation S250 will be described.

### Operation S250—Collecting Calibration Data.

After the calibration device 150 is mounted on the target equipment 20 and starts to perform calibration, the calibration device 150 collects calibration data from the target equipment 20 and transmits the collected calibration data to the operating computer 110.

As illustrated in FIG. 5, the calibration device 150 may be switched (e.g., may be automatically switched) to a measuring mode by using the relay 153e. For example, the calibration device 150 may switch a charging mode to a discharging mode, and vice versa. In addition, the calibration device 150 may switch a voltage measuring mode to a current measuring mode, and vice versa. In FIG. 5, the current measuring unit 153a includes a shunt resistor and an ammeter Iₛₑₙ. In FIG. 5, the relay 153e may be automatically switched to the measuring mode. In FIG. 5, C1 denotes a charging current calibration path, C2 denotes a charging voltage calibration path, and C3 denotes a discharging current calibration path. The power diode 153b, the power resistor 153c, and the power supply 153d simulate a battery. The power diode 153b cuts a reverse current off (e.g., prevents a reverse current flow).

Referring back to FIGS. 2 and 3, operation S260 will be described below.

### Operation S260—Calculating a Correction Factor.

The operating computer 110 calculates a correction factor to be applied to the target equipment 20 based on the calibration data.

### Operation S270—Storing a Correction Factor.

The operating computer 110 transmits the calculated correction factor to the target equipment 20, and the target equipment 20 stores the correction factor in the built-in memory. The stored correction factor is applied later when the target equipment 20 generates monitoring data (e.g., when the target equipment 20 is returned to normal service or operation). For example, monitoring data Y may be generated according to Equation 1 below. Here, the correction factor includes a slope A and an offset B. A measured value is denoted as x.

### Equation 1

$$Y = A \times x + B$$

The above method of operating a calibration system has been described with reference to the flowcharts illustrated in FIGS. 2 and 3. For simplicity, the method has been illustrated and described as a series of blocks, but the present disclosure is not limited to the order of the blocks, some blocks may occur in a different order or concurrently (or simultaneously) with other blocks illustrated and described herein, and various other branches, flow paths, and block orders that achieve the same or similar results may be implemented. In addition, not all of the illustrated blocks may be necessary to implement the method described herein.

In the description with reference to FIGS. 2 and 3, each operation may be further subdivided into a greater number of additional operations or combined into a fewer number of operations according to various embodiments of the present disclosure. In addition, some operations may be omitted, or the order between the operations may be changed. In addition, although other content is omitted, the content described with reference to FIG. 1 may be applied to the contents with reference to FIGS. 2 and 3. In addition, the contents with reference to FIGS. 2 to 7 may be applied to the contents with reference to FIG. 1.

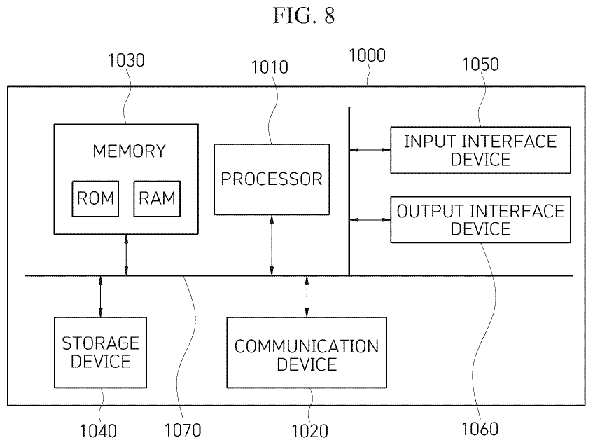

FIG. 8 is a block diagram illustrating a configuration of a computer system. In the calibration system 100, according to an embodiment of the present disclosure, the operating computer 110, the MES 120, and the ECS 130 may be implemented in the form of the computer system shown in FIG. 8.

Referring to FIG. 8, the computer system 1000 may include at least one processor 1010, a memory 1030, an input interface device 1050, an output interface device 1060, and a storage device 1040 that communicate via a bus 1070. The computer system 1000 may further include a communication device 1020 coupled to a network. The processor 1010 may be a central processing unit (CPU) or a semiconductor device that executes computer-readable commands stored in the memory 1030 or the storage device 1040. The memory 1030 and the storage device 1040 may include various types of volatile or nonvolatile storage media. For example, the memory 1030 may include read only memory (ROM) and random access memory (RAM). In various embodiments of the present disclosure, the memory 1030 may be positioned inside or outside the processor 1010, and the memory 1030 may be connected to the processor 1010 through various known means. The memory 1030 may be various types of volatile or nonvolatile storage media, and for example, the memory 1030 may include ROM or RAM.

Accordingly, embodiments of the present disclosure may be implemented as a method implemented on a computer or as a non-transitory computer-readable medium storing computer-executable commands. In one embodiment, when executed by the processor 1010, the computer-readable commands may perform a method according to at least one aspect of the present disclosure.

The communication device 1020 may transmit or receive a wired signal or a wireless signal.

In addition, the method of operating a calibration system according to embodiments of the present disclosure may be implemented in the form of program commands, which may be performed through various computer devices and recorded on a computer-readable medium.

The computer-readable medium may include program commands, data files, data structures, and the like, alone or in combination. The program commands recorded on the computer-readable recording medium may be designed and configured for embodiments of the present disclosure or may be known and available to those skilled in the field of computer software. The computer-readable recording medium may include a hardware device configured to store and perform the program commands. For example, the computer-readable recording medium may include magnetic media, such as a hard disk, a floppy disk, and a magnetic tape, optical media, such as a compact disc ROM (CD-ROM) and a digital video disk (DVD), and magneto-optical media, such as a floptical disk, a ROM, a RAM, and a flash memory. The program commands include not only machine language code such as that produced by a compiler but also high-level language code that may be executed by a computer using an interpreter or the like.

The processor 1010 executes computer-readable commands stored in the memory 1030 or the storage device 1040 to perform tasks, such as storing collected data, performing determination based on the collected data, generating information, or the like. The processor 1010 may transmit the generated information to an external calculation device via the communication device 1020.

According to an embodiment of the present disclosure, by automating an overall process of determination of a calibration time point and performing calibration, a calibration performing (preparing) time may be shortened and accuracy and precision of equipment may be consistently and constantly maintained. For example, by applying an equipment calibration system according to embodiments of the present disclosure to fields, voltage accuracy is in a range of about −0.025% to about +0.025%.

Aspects and features of the present disclosure are not limited to those described above, and other aspects and features not specifically mentioned herein will be clearly understood by those skilled in the art from the description of the present disclosure provided above and the claims as provided below.

Although the present disclosure has been described above with reference to example embodiments, those skilled in the art will understand that the present disclosure may be modified and changed variously without departing from the spirit and scope of the present disclosure as described in the appended claims and their equivalents.

What is claimed is:

1. A calibration system comprising:
a calibration device;
an operating computer configured to acquire monitoring data generated from calibration target equipment and to determine whether or not to perform calibration on the target equipment based on the monitoring data; and
a transport device configured to transport the calibration device and to mount the calibration device on the target equipment when it is determined that calibration is to be performed on the target equipment,
wherein the calibration device is configured to collect calibration data from the target equipment and to transmit the calibration data to the operating computer after the calibration device is mounted on the target equipment, and
wherein the operating computer is configured to calculate a correction factor for the monitoring data based on the calibration data.

2. The calibration system as claimed in claim 1, wherein the target equipment is a charger/discharger configured to charge and discharge a battery, and
wherein the monitoring data comprises voltage, current, and capacity measured when the target equipment charges and discharges the battery.

3. The calibration system as claimed in claim 1, wherein the operating computer is configured to:
periodically acquire the monitoring data from the target equipment; and
determine whether or not to perform calibration on the target equipment by using outlier analysis for the monitoring data.

4. The calibration system as claimed in claim 1, further comprising:
a manufacturing execution system; and
an equipment control system,
wherein the operating computer is configured to transmit a calibration alarm to the manufacturing execution system when it is determined that calibration is to be performed on the target equipment,
wherein the manufacturing execution system is configured to transmit information on a position of the target equipment to the equipment control system upon receiving the calibration alarm from the operating computer, and
wherein the equipment control system is configured to transmit a command for the position and movement to the transport device.

5. The calibration system as claimed in claim 4, wherein the transport device is configured to transport the calibration device to the position and to mount the calibration device on the target equipment upon receiving the command for the position and movement from the equipment control system.

6. The calibration system as claimed in claim 1, further comprising a sensor on a path toward the target equipment,
wherein the sensor is configured to generate a detection signal for the calibration device when the calibration device is within a reference distance from the sensor.

7. The calibration system as claimed in claim 1, wherein the calibration device is a battery-less structure comprising a diode and a resistor.

8. The calibration system as claimed in claim 2, wherein the calibration device is configured to automatically switch between a charging mode and a discharging mode of the target equipment by using a built-in relay.

9. The calibration system as claimed in claim 2, wherein the calibration device is configured to automatically switch between a current measuring mode and a voltage measuring mode by using a built-in relay.

10. The calibration system as claimed in claim 1, wherein the operating computer is configured to transmit the correction factor to the target equipment after calculating the correction factor.

11. The calibration system as claimed in claim 1, wherein the transport device is a stacker crane.

12. A method of operating a calibration system, the method comprising:
acquiring, by an operating computer, monitoring data generated from calibration target equipment;
determining, by the operating computer, whether or not to perform calibration on the target equipment based on the monitoring data;
transporting, by a transport device, a calibration device and mounting the calibration device on the target equipment when it is determined by the operating compute that calibration is to be performed on the target equipment;
collecting, by the calibration device, calibration data from the target equipment and transmitting the calibration data to the operating computer after the calibration device is mounted on the target equipment; and
calculating, by the operating computer, a correction factor for the monitoring data based on the calibration data.

13. The method as claimed in claim 12, further comprising transmitting, by the operating computer, the correction factor to the target equipment.

14. The method as claimed in claim 12, wherein the target equipment is a charger/discharger used for charging and discharging a battery, and
wherein the monitoring data comprises voltage, current, and capacity measured when the target equipment charges and discharges the battery.

15. The method as claimed in claim 12, wherein the determining of whether or not to perform the calibration comprises periodically acquiring, by the operating computer, the monitoring data from the target equipment and determining whether or not to perform calibration on the target equipment by using outlier analysis for the monitoring data.

16. The method as claimed in claim 12, wherein the transporting of the calibration device and the mounting of the calibration device on the target equipment comprises:
transmitting, by the operating computer, a calibration alarm to a manufacturing execution system when it is determined that calibration is to be performed on the target equipment;
transmitting, by the manufacturing execution system, information on a position of the target equipment to an equipment control system upon receiving the calibration alarm from the operating computer; and
transmitting, by the equipment control system, a command for the position and movement to the transport device.

17. The method as claimed in claim 12, wherein the transporting of the calibration device and the mounting of the calibration device on the target equipment comprises generating a detection signal for the calibration device when a sensor on a path toward the target equipment detects the calibration device.

18. The method as claimed in claim 12, wherein the calibration device is a battery-less structure comprising a diode and a resistor.

19. The method as claimed in claim 14, wherein the calibration device automatically switches between a charging mode and a discharging mode of the target equipment by using a built-in relay.

20. The method as claimed in claim 14, wherein the calibration device automatically switches between a current measuring mode and a voltage measuring mode by using a built-in relay.
